(19) United States
(12) Patent Application Publication
(10) Pub. No.: US 2023/0254070 A1
(43) Pub. Date: Aug. 10, 2023

(54) METHOD AND SYSTEM FOR A HYBRID AUTOMATIC REPEAT REQUEST (HARQ) PROCESS IN A NR MBS

(71) Applicant: SAMSUNG ELECTRONICS CO., LTD., Suwon-si (KR)

(72) Inventors: Vinay Kumar SHRIVASTAVA, Bangalore (IN); Sangkyu BAEK, Suwon-si (KR)

(21) Appl. No.: 18/166,364

(22) Filed: Feb. 8, 2023

(30) Foreign Application Priority Data
Feb. 8, 2022 (IN) 202241006635
Jan. 27, 2023 (IN) 2022 41006635

(51) Int. Cl. H04L 1/1812; H04L 12/18; H04W 72/232; H04W 72/12; H04L 5/00

(52) U.S. Cl. CPC H04L 1/1816; H04L 12/189; H04W 72/232; H04W 72/12; H04L 5/0055

(57) ABSTRACT

The disclosure relates to a 5G or 6G communication system for supporting a higher data transmission rate. Present disclosure provides a method performed by a user equipment (UE) in a wireless communication system. The method includes obtaining a transport block (TB) of a transmission associated with a hybrid automatic repeat request (HARQ) process; determining that the transmission is a new transmission based on a first condition, wherein the first condition includes that: the HARQ process is associated with a transmission indicated with a multicast, and broadcast service control channel-radio network temporary identifier (MCCH-RNTI) for a multicast and broadcast service (MBS) broadcast and the transmission is a first received transmission for the TB according to an MCCH schedule indicated by a radio resource control (RRC), or the HARQ process is associated with a transmission indicated with a group-RNTI (G-RNTI) for a MBS broadcast, and the transmission is a first received transmission for the TB according to a multicast and broadcast service traffic channel (MTCH) schedule indicated by the RRC or according to a schedule indicated by a downlink control indicator (DCI).

### CROSS-REFERENCE TO RELATED APPLICATIONS

This application is based on and claims priority under 35 U.S.C. § 119 to Indian Patent Application No. 202241006635 filed on Feb. 8, 2022, and Indian Patent Application No. 202241006635 filed on Jan. 27, 2023, in the Indian Intellectual Property Office, the disclosures of which are incorporated by reference herein in their entirety.

### BACKGROUND

### 1. Field

The present disclosure relates, in general, to wireless communication networks. Particularly, the present disclosure relates to a method and a system for a hybrid automatic repeat request (HARQ) process in a new radio multicast broadcast service (NR MBS).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Disclosed herein is a method performed by a user equipment (UE) in a wireless communication system. The method includes obtaining a transport block (TB) of a transmission associated with a hybrid automatic repeat request (HARQ) process; determining that the transmission is a new transmission based on a first condition, wherein the first condition includes that: the HARQ process is associated with a transmission indicated with a multicast, and broadcast service control channel-radio network temporary identifier (MCCH-RNTI) for a multicast and broadcast service (MBS) broadcast and the transmission is a first received transmission for the TB according to an MCCH schedule indicated by a radio resource control (RRC), or the HARQ process is associated with a transmission indicated with a group-RNTI (G-RNTI) for a MBS broadcast, and the transmission is a first received transmission for the TB according to a multicast and broadcast service traffic channel (MTCH) schedule indicated by the RRC or according to a schedule indicated by a downlink control indicator (DCI).

Further, disclosed herein is a user equipment (UE) in a wireless communication system. The UE includes a transceiver; and a controller coupled with the transceiver and configured to: obtain a transport block (TB) of a transmission associated with a hybrid automatic repeat request (HARQ) process; determine that the transmission is a new transmission based on a first condition, wherein the first condition includes that: the HARQ process is associated with a transmission indicated with a multicast, and broadcast service control channel-radio network temporary identifier (MCCH-RNTI) for a multicast and broadcast service (MBS) broadcast and the transmission is a first received transmission for the TB according to an MCCH schedule indicated by a radio resource control (RRC), or the HARQ process is associated with a transmission indicated with a group-RNTI (G-RNTI) for a MBS broadcast, and the transmission is a first received transmission for the TB according to a multicast and broadcast service traffic channel (MTCH) schedule indicated by the RRC or according to a schedule indicated by a downlink control indicator (DCI).

The foregoing summary is illustrative only and is not intended to be in any way limiting. In addition to the illustrative aspects, embodiments, and features described above, further aspects, embodiments, and features will become apparent by reference to the drawings and the following detailed description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 illustrates an environment for a HARQ process of a UE receiving a NR MBS in accordance with some embodiments of the present disclosure;

FIG. 2A illustrates a UE receiving a NR MBS for a HARQ process in accordance with some embodiments related to transmission and retransmission of the present disclosure;

FIG. 2B illustrates a UE receiving a NR MBS for a HARQ process, in accordance with some embodiments related to HARQ feedback generation and no feedback generation of the present disclosure;

FIG. 3 illustrates a flowchart of a method for operating a HARQ process of a UE receiving a NR MBS in accordance with some embodiments related to transmission and retransmission of the present disclosure;

FIG. 4 illustrates a flowchart of a method for operating a HARQ process of a UE receiving a NR MBS in accordance with some embodiments related to HARQ feedback generation and no feedback generation of the present disclosure;

FIG. 5 illustrates a flowchart of a method for determining a downlink assignment for HARQ process for MCCH in accordance with some embodiments of the present disclosure;

FIG. 6 illustrates a flowchart of a method for determining a downlink assignment for HARQ process for MTCH in accordance with some embodiments of the present disclosure;

FIG. 7 illustrates a computer system for implementing embodiments consistent with the present disclosure; and

FIG. 8 illustrates a UE according to embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

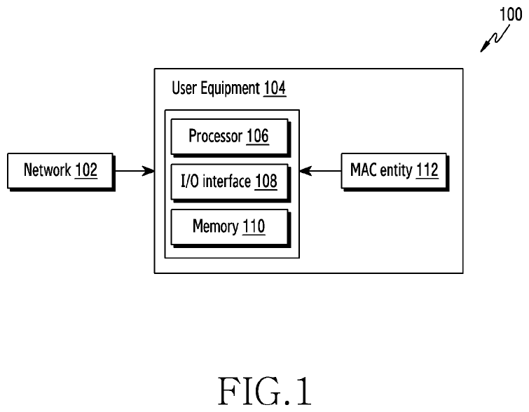

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Other technical features may be readily apparent to one skilled in the art from the following figures, descriptions, and claims.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises,” “comprising,” “includes,” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure discloses a method performed by a user equipment (UE) in a wireless communication system. The method includes obtaining a transport block (TB) of a transmission associated with a hybrid automatic repeat request (HARQ) process; determining that the transmission is a new transmission based on a first condition, wherein the first condition includes that: the HARQ process is associated with a transmission indicated with a multicast, and broadcast service control channel-radio network temporary identifier (MCCH-RNTI) for a multicast and broadcast service (MBS) broadcast and the transmission is a first received transmission for the TB according to an MCCH schedule indicated by a radio resource control (RRC), or the HARQ process is associated with a transmission indicated with a group-RNTI (G-RNTI) for a MBS broadcast, and the transmission is a first received transmission for the TB according to a multicast and broadcast service traffic channel (MTCH) schedule indicated by the RRC or according to a schedule indicated by a downlink control indicator (DCI).

In some embodiments, the method further includes in case that the transmission is the new transmission, decoding data included in the TB, and delivering the decoded data to an entity.

In some embodiments, the method further includes in case that the transmission is the new transmission, decoding data included in the TB, and delivering the decoded data to an entity.

In some embodiments, wherein, in case that the HARQ process is associated with the transmission indicated with the MCCH-RNTI, the transmission includes a downlink assignment and redundancy version for the HARQ process.

In some embodiments, wherein RRC configuration information for the transmission includes a physical downlink shared channel (PDSCH) aggregation factor indicating a number of repeated transmissions for the TB.

In some embodiments, wherein the entity includes a disassembly and demultiplexing entity.

In some embodiments, the method further includes identifying whether an instruction a physical layer to generate acknowledgment feedback is instructed based on a second condition being satisfied, the second condition including that: the HARQ process is associated with a transmission indicated with a G-RNTI or a G-configured scheduling-RNTI (G-CS-RNTI) for a MBS multicast and a HARQ feedback is disabled, or the HARQ process is associated with the transmission indicated with the G-RNTI or the G-CS-RNTI for the MBS multicast and a negative acknowledgement (NACK) only HARQ feedback is configured and the data for the TB is successfully decoded, not instructing the instruction the physical layer to generate acknowledgment feedback based on the second condition being satisfied.

In some embodiments, wherein the HARQ process is performed by at least one medium access control (MAC) entity of the UE.

In some embodiments, the method further includes receiving scheduling information for one of: the MCCH from radio resource control (RRC) configuration prior to receiving the transmission, or the MTCH from at least one of the RRC configuration prior to receiving the transmission and a DCI signaling during the transmission, wherein the scheduling information comprises transmission associated information.

In some embodiments, wherein the transmission associated information comprises at least one of time of occurrence of the transmission, a start of the transmission, a duration of the transmission, a downlink assignment, a redundancy version and HARQ information for the transmission.

The present disclosure is a user equipment (UE) in a wireless communication system. The UE includes a transceiver; and a controller coupled with the transceiver and configured to: obtain a transport block (TB) of a transmission associated with a hybrid automatic repeat request (HARQ) process; determine that the transmission is a new transmission based on a first condition, wherein the first condition includes that: the HARQ process is associated with a transmission indicated with a multicast, and broadcast service control channel-radio network temporary identifier (MCCH-RNTI) for a multicast and broadcast service (MBS) broadcast and the transmission is a first received transmission for the TB according to an MCCH schedule indicated by a radio resource control (RRC), or the HARQ process is associated with a transmission indicated with a group-RNTI (G-RNTI) for a MBS broadcast, and the transmission is a first received transmission for the TB according to a multicast and broadcast service traffic channel (MTCH) schedule indicated by the RRC or according to a schedule indicated by a downlink control indicator (DCI).

In some embodiments, the method further includes determining a requirement of HARQ feedback generation or no HARQ feedback generation for the HARQ process associated with the transmission based on one or more second conditions and performing one of instructing a physical layer to generate feedback of the data in the TB, upon determining the requirement of the HARQ feedback generation for the HARQ process or instructing the physical layer to not generate feedback of the data in the TB, upon determining the requirement of no HARQ feedback generation for the HARQ process. Thus, the present disclosure provides a standardized approach and specified approach for the HARQ process including HARQ process assignment and/or usage for NR MBS broadcast, repetitions for the NR MBS broadcast, determination for the new transmission and the retransmission for the NR MBS broadcast, determination for the HARQ feedback generation or no HARQ feedback generation for NR MBS multicast and the NR MBS broadcast.

This standardized approach ensures inter-operability between the UEs and the network such that the UE implementation is governed and guided. Further, the present disclosure ensures accuracy, efficiency of the operation and UE/network which are able to achieve NR MBS operation in an optimum manner with respect to well designed and specified approaches for HARQ process operation, transmission/retransmission and HARQ feedback generation.

In existing techniques, two delivery methods are envisioned for fifth generation (5G) MBS service, from a viewpoint of a 5G core network (CN) i.e., an individual MBS traffic delivery method, and a shared MBS traffic delivery method. In the case of the individual MBS traffic delivery method, the CN receives a single copy of MBS data packets and delivers separate copies of those MBS data packets to individual UEs via per-UE protocol data unit (PDU) sessions.

In the case of the shared MBS traffic delivery method, the 5G CN may receive a single copy of the MBS data packets and delivers a single copy of those MBS packets to a radio access node (RAN). Thereafter, RAN may deliver the single copy of the MBS packets to one or multiple UEs. The RAN delivers MBS data to the UEs using either one of point-to-point delivery (PTP) or point-to-multipoint (PTM) delivery. Further, at the UE, the MBS bearer may be composed of a common packet data convergence protocol (PDCP) entity with PTP, PTM or a combination of PTP and PTM legs or radio link control (RLC) entities.

A HARQ process may be required to support MBS multicast e.g., for transmission and/or retransmission on PTM, for the transmission and/or the retransmission on PTP or for initial transmission on the PTM followed by the retransmission on the PTP. In the existing techniques a media access control (MAC) entity includes the HARQ entity for each serving cell, which maintains a number of parallel HARQ processes. Each HARQ process may be associated with a HARQ process identifier. The HARQ entity may direct HARQ information and associated transport blocks (TBs) received on the downlink-shared channel (DL-SCH) to the corresponding HARQ processes.

Further, there are a number of parallel DL HARQ processes per HARQ entity. The dedicated broadcast HARQ process is used for broadcast control channel (BCCH). The HARQ process supports one TB when a physical layer is not configured for downlink spatial multiplexing. The HARQ process supports one or two TBs when the physical layer is configured for downlink spatial multiplexing.

When the HARQ process performs the transmission and/or the retransmission as part of MBS multicast it may be possible to perform blind retransmission or multiple repetitions in order to enhance the reliability. However, there is no specified behavior or mechanism for the NR MBS broadcast. Therefore, an approach is needed to clearly specify the behavior for the NR MBS broadcast in the HARQ process operation like there is a specified mechanism for unicast service. Further, for the NR MBS broadcast and the NR MBS multicast, the determination of requirement of feedback generation or no feedback generation is also not specified. Therefore, there is a need to specify the behavior for the NR MBS in the HARQ process operation in the context of the transmission and the feedback generation.

The information disclosed in this background of the disclosure section is only for enhancement of understanding of the general background of the invention and should not be taken as an acknowledgement or any form of suggestion that this information forms the prior art already known to a person skilled in the art.

FIG. 1 illustrate an environment (100) for a HARQ process of UE (104) receiving a new radio multicast and broadcast service (NR MBS) in accordance with some embodiments of the present disclosure.

The environment (100) includes a network (102), the UE (104), and the like. The network (102) may share a transmission comprising a TB for at least one of MCCH or MTCH to the UE (104). In some embodiments, the TB may also be referred as MBS MAC PDU in the context of the present disclosure. The network (102) in the context of the present disclosure may include components such as eNodeB, GnodeB and the like, that may enable one of a wired communication network, a wireless communication network or a combination of both wired and wireless communication network. In some embodiments, the TB for the HARQ process may be allocated for the HARQ process based on a downlink assignment indicated for the HARQ process for MCCH addressed by MCCH-RNTI. Similarly, in some embodiments, the TB for the HARQ process may be allocated for the HARQ process based on the downlink assignment indicated for the HARQ process for MTCH addressed by G-RNTI.

The UE (104) includes a processor (106), a memory (110) and an input/output (I/O) interface (108). The processor (106), the memory (110) and the I/O interface (108) may be associated with a MAC entity (112) of the UE (104) to perform the functions as given below. In some embodiments, the I/O interface (108) may receive the transmission from the network (102).

In some embodiments, the I/O interface (108) may receive scheduling information from RRC configuration prior to receiving the transmission. In some other embodiments, the processor (106) may receive the scheduling information from DCI signaling during the transmission. When the MAC entity (112) reads the MCCH scheduling information from the RRC configuration and/or MTCH based on the scheduling information from at least one of the RRC configuration and/or the DCI signaling, the scheduling information may include at least one of transmission associated information, and a PDSCH aggregation factor. The transmission associated information may include at least one of time of occurrence of the transmission, start of the transmission, duration of the transmission, a downlink assignment, a redundancy version and HARQ information for the transmission.

In some embodiments, the PDSCH Aggregation Factor indicates number of repeated transmissions for the TB. In these repetitions, the scheduling information received initially from at least one of the RRC configuration and the DCI signaling is repeated. In some embodiments, if the scheduling information is received prior to receiving the transmission for the HARQ process, and if the downlink assignment for this PDCCH occasion may have been received on the PDCCH for MCCH-RNTI, then the downlink assignment and the redundancy version is indicated for the selected HARQ process based on the scheduling information from RRC configuration.

In some embodiments, if the scheduling information is received from at least one of the RRC configuration and the DCI signaling during the transmission, and if the downlink assignment for this PDCCH occasion may have been received on the PDCCH for the G-RNTI configured for broadcast MTCH, then the presence of downlink assignment, the redundancy version and associated HARQ information is indicated for the selected HARQ process based on the scheduling information from at least one of the RRC configuration and the DCI signaling.

In some embodiments, the processor (106) may determine the received transmission to be one of a new transmission or the retransmission based on the one or more first conditions related to at least one of the HARQ process, the MCCH and the MTCH. For example, the one or more first conditions may include, but not limited to, inferring the transmission is the new transmission, (1) if the transmission is a first transmission for the TB according to the scheduling information indicated by at least one of the RRC configuration or the DCI signaling, (2) if the transmission is for the HARQ process of the MCCH addressed by the MCCH-RNTI and the transmission is the first received transmission for the TB according to scheduling information of the MCCH indicated by the RRC configuration and (3) if the transmission is for the HARQ process of the MTCH addressed by a G-RNTI for MBS broadcast and the transmission is the first received transmission for the TB according to the scheduling information of the MTCH indicated by the RRC configuration or according to the scheduling indicated by the DCI signaling.

Further, in some embodiments, if the transmission is inferred as the new transmission, then the processor (106) may decode a received data for the TB in the transmission. In some embodiments, if the transmission is inferred as the retransmission, then the processor (106) may decode the TB by combining the data received in the TB with stored data related to the TB. Further, the processor (106) may deliver the decoded data to one or more entities. The one or more entities may include, but not limited to, at least one of disassembly entities and demultiplexing entities.

Further the processor (106) may determine requirement of HARQ feedback generation, or no HARQ feedback generation based on one or more second conditions related to at least one of the HARQ process, the MCCH and the MTCH. For example, the one or more second conditions for inferring requirement of no HARQ feedback generation may include, but not limited to, (1) the HARQ process is associated with the transmission for the MCCH addressed by the MCCH-RNTI, (2) the HARQ process is associated with the transmission for the NR MBS broadcast addressed by a G-RNTI, (3) the HARQ process is associated with the transmission for NR MBS multicast addressed by the G-RNTI or a G-CS-RNTI and the HARQ feedback is disabled.

In some embodiments, the HARQ feedback is disabled by one of: the RRC configuration or the DCI signaling. Further, the one or more second conditions for no HARQ feedback generation may include, but not limited to (4) the HARQ process is associated with the transmission for the NR MBS multicast and the HARQ feedback is not configured and (5) the HARQ process is associated with the transmission for the NR MBS multicast, and the HARQ process for the transmission is configured for NACK only HARQ feedback and the decoding of the data in this TB is successful.

Further, the processor (106) may instruct the physical layer to generate feedback or not to generate feedback of the data in the TB, upon determining the requirement of the HARQ feedback generation or no HARQ feedback generation for the HARQ process. For instance, the processor (106) may instruct the physical layer to generate feedback of the data in the TB, when the processor (106) determines the requirement of the HARQ feedback generation for the HARQ process. Similarly, the processor (106) may instruct the physical layer to not generate feedback of the data in the TB, when the processor (106) determines the requirement of no HARQ feedback generation for the HARQ process.

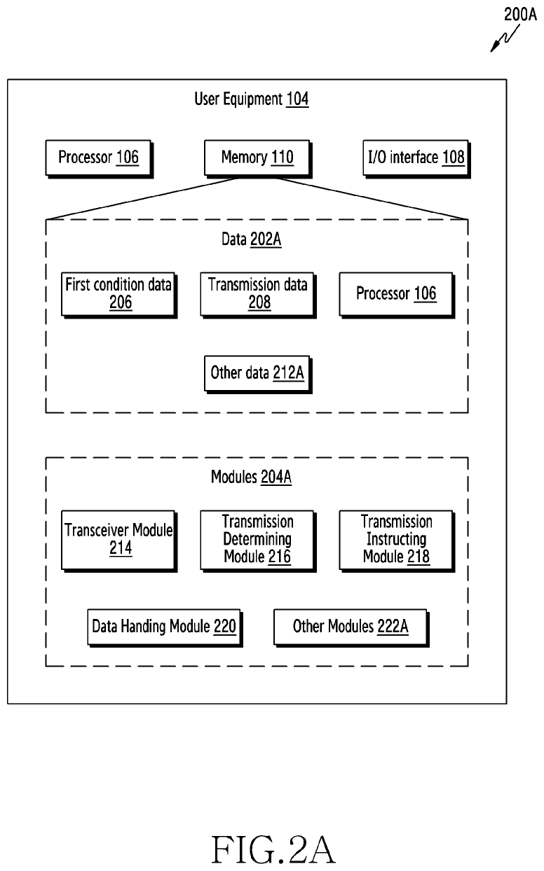

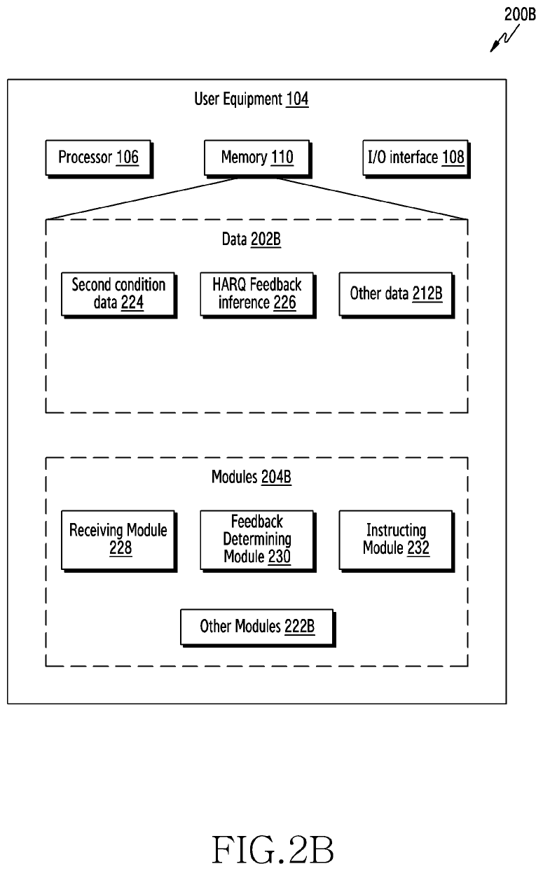

FIG. 2A illustrates a block diagram (200A) of a UE (104) receiving a NR MBS for a HARQ process in accordance with some embodiments related to transmission and retransmission of the present disclosure.

The UE (104) may include a processor (106), an I/O interface (108) and a memory (110). The I/O interface (108) may be configured for receiving and transmitting an input signal or/and an output signal related to one or more operations of the UE (104). The memory (110) may be communicatively coupled to the processor (106) and one or more modules (204). The processor (106) may be configured to perform one or more functions of the UE (104) for performing multiple-turn actions using data (202A) and the one or more modules (204).

In an embodiment, the data (202A) stored in the memory (110) may include without limitation first condition data (206), transmission data (208), transmission inference data (210) and other data (212A). In some implementations, the data (202A) may be stored within the memory (110) in the form of various data structures. Additionally, the data (202A) may be organized using data models. The other data (212A) may include various temporary data and files generated by the different components of the UE (104).

In some embodiments, the first condition data (206) may include one or more first conditions required to provide an inference if the received transmission comprising a TB is a new transmission or a retransmission. The one more first conditions may include, but not limited to, as follows:
The transmission may be inferred to be the new transmission if the transmission is a first transmission for the TB according to scheduling information indicated by at least one of RRC configuration or DCI signaling;
Further, the transmission is inferred to be the new transmission if the transmission is for the HARQ process of MCCH addressed by an MCCH-RNTI and the transmission is a first received transmission for the TB according to the scheduling information of the MCCH indicated by the RRC configuration; and
Further, the transmission may be inferred to be the new transmission if the transmission is for the HARQ process of MTCH addressed by a G-RNTI for the MBS broadcast and the transmission is the first received transmission for the TB according to the scheduling information of the MTCH indicated by the RRC configuration or according to the scheduling information indicated by the DCI signaling.

Further, in some embodiments the first condition data (206) also comprises negation of the one or more first conditions that enables in inferring the transmission as the retransmission.

In some embodiments, negation of at least one of the one or more first conditions mentioned above may infer the transmission to be the retransmission. As an example, the negation of the one or more first conditions for inferring the transmission to be the retransmission may be as shown below:
The transmission may be inferred to be the retransmission if the transmission is not first transmission for the TB according to scheduling information indicated by at least one of the RRC configuration or the DCI signaling;
Further, the transmission is inferred to be the retransmission if the transmission is for the HARQ process of the MCCH addressed by the MCCH-RNTI and the transmission is not the first received transmission for the TB according to the scheduling information of the MCCH indicated by the RRC configuration; and
Further, the transmission may be inferred to be the retransmission if the transmission is for the HARQ process of the MTCH addressed by the G-RNTI and the transmission is not the first received transmission for the TB according to the scheduling information of the MTCH indicated by at least one of the RRC configuration and the DCI signaling.

In some embodiments, the transmission data (208) may include the transmission comprising the TB for at least one of the MCCH and the MTCH received from a network (102) and related information.

In some embodiments, the transmission inference data (210) may include inferences made related to the new transmission or the retransmission based on the first condition data (206).

In some embodiments, the data (202A) may be processed by the one or more modules (204A) of the UE (104). In an implementation, the one or more modules (204A) may include, without limiting to, a transceiver module (214), a transmission determining module (216), a transmission instructing module (218), a data handling module (220) and other modules (222A) In an embodiment, the other modules (222A) may be used to perform various miscellaneous functionalities of the UE (104). It will be appreciated that such one or more modules (204A) may be represented as a single module or a combination of different modules.

The transceiver module (214) may be configured to receive the transmission. The transmission may include the TB for at least one of the MCCH and the MTCH from the network (102) for implementing the HARQ process. In the context of the present disclosure, the network (102) may be referred to as eNodeB, gNodeB and the like. In some embodiments, the HARQ process is operated by the at least one MAC entity (112) of the UE (104). Further the transceiver module (214) may be configured to receive information for one of the MCCH from the RRC configuration prior to receiving the transmission or the MTCH from at least one of the RRC configuration prior to receiving the transmission and the DCI signaling during the transmission. The scheduling information comprises at least one of transmission associated information, and a PDSCH aggregation factor.

The transmission associated information may include, but not limited to, at least one of time of occurrence of the transmission, start of the transmission, duration of the transmission, a downlink assignment, a redundancy version and HARQ information for the transmission. The PDSCH aggregation factor may indicate number of repeated transmissions for the TB. In some embodiments, for each repetition, scheduling information received initially from at least one of the RRC configuration and the DCI signaling may be repeated. For example, the DCI signaling may provide the scheduling information including, but not limited to, a frequency domain resource assignment, a time domain resource assignment, and redundancy version.

Exemplary scheduling information is shown below. However, this is only for the purpose of illustration and should not be construed as a limitation of the present disclosure. Consider the RRC configuration in SIB20. In this, the scheduling information carried for the MCCH may include parameters such as MCCH-RepetitionPeriodAndOffset, MCCH-WindowStartSlot, MCCH-WindowDuration and MCCH-ModificationPeriod. Based on the aforementioned parameters, the UE (104) may be aware of time window for the MCCH. In some embodiments, for the MTCH, the scheduling information may be provided through a MCCH channel in a form of discontinuous reception (DRX) configurations for the broadcast services that may define Active Time for each of the broadcast service (MTCH) reception.

In some embodiments, the transmission determining module (216) may be configured to determine the received transmission to be one of the new transmission or the retransmission based on one or more first conditions defined as part of the first condition data (206) related to at least one of the HARQ process, the MCCH and the MTCH. As an example, consider the transmission received from the network (102) is for the HARQ process of the MCCH. Further, consider that the UE (104) had received scheduling information prior to receiving the transmission. The scheduling information is related to the MCCH via the RRC configuration. When the transmission is received, the transmission determining module (216) may determine whether the transmission is for the MCCH based on the MCCH-RNTI.

Since, the scheduling information as well includes information related to the MCCH, the transmission determining module (216) determines that the transmission is correctly received for the HARQ process of the MCCH. Thereafter, the transmission determining module (216) determines whether the received transmission for the HARQ process of the MCCH is a first transmission based on the scheduling information. In this scenario, since the scheduling information proved that the received transmission is the first transmission, then the transmission determining module (216) infers the transmission to be the new transmission. On the contrary, in the above scenario, if the transmission is not the first transmission as per the scheduling information, then the received transmission may be inferred as the retransmission.

As another example, consider the transmission received from the network (102) is for the HARQ process of the MTCH. Further, consider that the UE (104) had received scheduling information prior to receiving the transmission via the RRC configuration or according to the scheduling information indicated by the DCI signaling. When the transmission is received, the transmission determining module (216) may determine whether the transmission is for the MTCH based on the G-RNTI. Since, the scheduling information as well includes information related to the MTCH, the transmission determining module (216) determines that the transmission is correctly received for the HARQ process of the MTCH.

Thereafter, the transmission determining module (216) determines whether the received transmission for the HARQ process of the MTCH is a first transmission based on the scheduling information. In this scenario, since the scheduling information proved that the received transmission is the first transmission, then the transmission determining module (216) infers the transmission to be the new transmission. On the contrary, in the above scenario, if the transmission is not the first transmission as per the scheduling information, then the received transmission may be inferred as the retransmission.

In some embodiments, if the transmission is the new transmission, the transmission instructing module (218) may be configured to perform decoding a received data for the TB in the transmission. In some embodiments, if the transmission is the retransmission, the transmission instructing module (218) may be configured to perform decoding the TB by combining the data received in the TB with stored data related to the TB.

In some embodiments, the data handling module (220) may be configured to deliver the decoded data to one or more entities associated with the UE (104). The one or more entities may include, but not limited to, at least one of disassembly entities and demultiplexing entities.

FIG. 2B illustrates a block diagram (200B) of a UE (104) receiving a NR MBS for a HARQ process, in accordance with some embodiments related to HARQ feedback generation and no feedback generation of the present disclosure.

In an embodiment, data (202B) stored in the memory (110) may include without limitation, second condition data (224), HARQ feedback inference data (226) and other data (212B). In some implementations, the data (202B) may be stored within the memory (110) in the form of various data structures. Additionally, the data (202B) may be organized using data models. The other data (212B) may include various temporary data and files generated by the different components of the UE (104).

In some embodiments, the second condition data (224) may include one or more second conditions required to determine requirement of the HARQ feedback generation or no HARQ feedback generation for the HARQ process associated with the transmission. The one or more second conditions may include, but not limited to, as follows:
The HARQ process may not require the HARQ feedback generation when the HARQ process is associated with the transmission for the MCCH addressed by the MCCH-RNTI;
Further, the HARQ process may not require the HARQ feedback generation when the HARQ process is associated with the transmission for NR MBS broadcast addressed by the G-RNTI;
Further the HARQ process may not require the HARQ feedback generation when the HARQ process is associated with the transmission for NR MBS multicast addressed by the G-RNTI or a G-CS-RNTI and the HARQ feedback is disabled by the network through one of the RRC configuration or the DCI signaling;
Further the HARQ process may not require the HARQ feedback generation when the HARQ process is associated with the transmission for the NR MBS multicast addressed by the G-RNTI or the G-CS-RNTI and the HARQ feedback is not configured; and
Further the HARQ process may not require the HARQ feedback generation when the HARQ process is associated with the transmission for the NR MBS multicast addressed by the G-RNTI or the G-CS-RNTI and the HARQ process for the transmission is configured for NACK only HARQ feedback and decoding of the data in this TB is successful.

In some embodiments, the one or more second conditions may include when the HARQ process is associated with the transmission for the NR MBS multicast indicated by configured multicast downlink assignment and the HARQ feedback is disabled, when the HARQ process is associated with the transmission for the NR MBS multicast indicated by configured multicast downlink assignment and the HARQ feedback is not configured, and when the HARQ process is associated with the transmission for the NR MBS multicast indicated by configured multicast downlink assignment, and the HARQ process for the transmission is configured for the NACK only HARQ feedback and decoding of the data in this TB is successful. That is, in these cases, the HARQ process may not require the HARQ feedback generation.

Further, in some embodiments the second condition data (224) also comprises negation of the one or more second conditions that enables in inferring the requirement of the HARQ feedback generation.

As an example, the negation of the one or more second conditions for inferring the requirement of the feedback generation may include:
The HARQ process may require the HARQ feedback generation when the HARQ process is not associated with the transmission for the MCCH addressed by the MCCH-RNTI;
Further, the HARQ process may require the HARQ feedback generation when the HARQ process is not associated with the transmission for the NR MBS broadcast addressed by the G-RNTI;
Further the HARQ process may require the HARQ feedback generation when the HARQ process is associated with the transmission for the NR MBS multicast (e.g., addressed by the G-RNTI or the G-CS-RNTI or indicated by a configured multicast downlink assignment) and the HARQ feedback is not disabled by the network through one of the RRC configuration or the DCI signaling;
Further the HARQ process may require the HARQ feedback generation when the HARQ process is associated with the transmission for the NR MBS multicast (e.g., addressed by the G-RNTI or the G-CS-RNTI or indicated by a configured multicast downlink assignment) and the HARQ feedback is configured;
Further the HARQ process for the transmission may require the HARQ feedback generation when the HARQ process is associated with the transmission for MBS multicast (e.g., addressed by the G-RNTI or the G-CS-RNTI or indicated by a configured multicast downlink assignment), and the HARQ process is configured for the NACK-only HARQ feedback and the decoding of the data in this TB is unsuccessful; and
Further the HARQ process for the transmission may require the HARQ feedback generation when the HARQ process is associated with the transmission for MBS multicast (e.g., addressed by the G-RNTI or the G-CS-RNTI or indicated by the configured multicast downlink assignment), and the HARQ process is not configured for the NACK-only HARQ feedback and the decoding of the data in this TB is successful.

In some embodiments, the HARQ feedback inference data (226) may also include inferences made related to requirement of the HARQ feedback generation or no HARQ feedback generation for the transmission based on the second condition data (224).

In some embodiments, the data (202B) may be processed by one or more modules (204B) of the UE (104). In an implementation, the one or more modules (204B) may include, without limiting to, a receiving module (228), a feedback determining module (230), instructing module (232) and other modules (222B). In an embodiment, the other modules (222B) may be used to perform various miscellaneous functionalities of the UE (104). It will be appreciated that such the one or more modules (204B) may be represented as a single module or a combination of different modules.

In some embodiments, the receiving module (228) may be configured to receive the transmission. The transmission may include the TB for at least one of the MCCH and the MTCH from the network (102) for implementing the HARQ process.

In some embodiments, the feedback determining module (230) may be configured to determine a requirement of the HARQ feedback generation or no HARQ feedback generation for the HARQ process associated with the transmission based on the one or more second conditions defined as part of the second condition data (224) related to at least one of the HARQ process. As an example, consider the transmission received from the network (102) is for the HARQ process of the MTCH multicast and the transmission is configured for NACK only HARQ feedback. This means that, when the TB which is received as part of the transmission cannot be successfully decoded, the feedback may be generated since the transmission is configured for the NACK only HARQ feedback. However, consider that, in this scenario, the TB is decoded successfully. In such cases, since the result is successful, the feedback may not be generated as the configuration indicates the NACK only HARQ feedback.

In some embodiments, the instructing module (232) may instruct a physical layer to generate HARQ feedback of the data in the TB, upon determining the requirement of the HARQ feedback generation for the HARQ process. In some embodiments, when the requirement of no HARQ feedback generation for the HARQ process is determined, the instructing module (232) may instruct the physical layer to not generate feedback of the data in the TB.

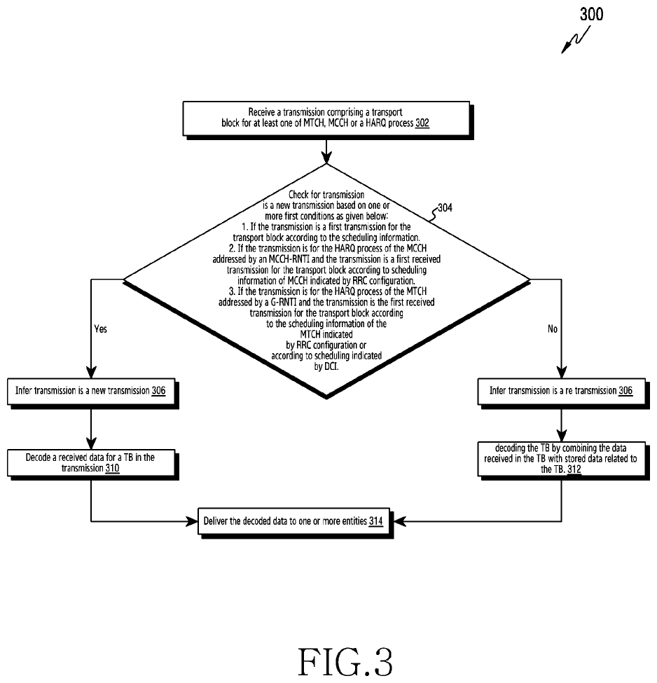

FIG. 3 illustrates a flowchart of a method (300) for operating a HARQ process of a UE (104) receiving a NR MBS in accordance with some embodiments related to transmission and retransmission of the present disclosure.

As illustrated in FIG. 3, the method (300) includes one or more blocks illustrating a method (300) for the HARQ process of the UE (104) receiving the NR MBS. The method (300) may be described in the general context of computer executable instructions. Generally, computer executable instructions can include routines, programs, objects, components, data structures, procedures, modules, and functions, which perform functions or implement abstract data types.

The order in which the method (300) is described is not intended to be construed as a limitation, and any number of the described method blocks can be combined in any order to implement the method (300). Additionally, individual blocks may be deleted from the methods without departing from the spirit and scope of the subject matter described herein. Furthermore, the method (300) can be implemented in any suitable hardware, software, firmware, or combination thereof.

At block 302, the method (300) includes receiving, by a processor (106) of the UE (104), a transmission comprising a TB for at least one of MCCH and the MTCH from a network (102), for implementing the HARQ process.

At block 304, the method (300) includes determining, by the processor (106), the received transmission to be one of a new transmission or a retransmission based on one or more first conditions related to at least one of the HARQ process, the MCCH and the MTCH for the NR MB S broadcast.

In some embodiments, the one or more first conditions may include, (1) if the transmission is a first transmission for the TB according to the scheduling information indicated by at least one of the RRC configuration or the DCI signaling, (2) if the transmission is for the HARQ process of the MCCH addressed by the MCCH-RNTI and the transmission is the first received transmission for the TB according to scheduling information of the MCCH indicated by the RRC configuration, and (3) if the transmission is for the HARQ process of the MTCH addressed by a G-RNTI for the MBS broadcast and the transmission is the first received transmission for the TB according to the scheduling information of the MTCH indicated by the RRC configuration or according to the scheduling information indicated by the DCI signaling,

If any of the first conditions are met, then the method proceeds to block 306 via “Yes.” At block 306, the method includes inferring transmission as the new transmission else upon negation of the one or more first conditions, the method proceed to block 308 via “No.” At block 308, the method includes “inferring the transmission to be the retransmission.

At block 306, the method includes inferring, by the processor (106), the transmission is the new transmission, then at block 310, the method (300) includes decoding, by the processor (106) a received data for the TB in the transmission.

In some embodiments, At block 308, the method includes inferring, by the processor (106) the transmission is the retransmission, then at block 312, the method (300) includes decoding, by the processor, the TB by combining the data received in the TB with stored data related to the TB when the transmission is the retransmission. As an example, consider the received transmission is the retransmission since the received transmission is not a first transmission and the transmission is not for the HARQ process of the MCCH addressed by the MCCH-RNTI, then in such a case, the UE (104) may instruct the physical layer to combine the received data with the data currently in the soft buffer for this TB and attempt to decode the combined data.

At block 314, the method (300) includes delivering, by the processor (106), the decoded data to one or more entities associated with the UE (104). In some embodiments, the one or more entities may include, but not limited to, disassembly entities and demultiplexing entities.

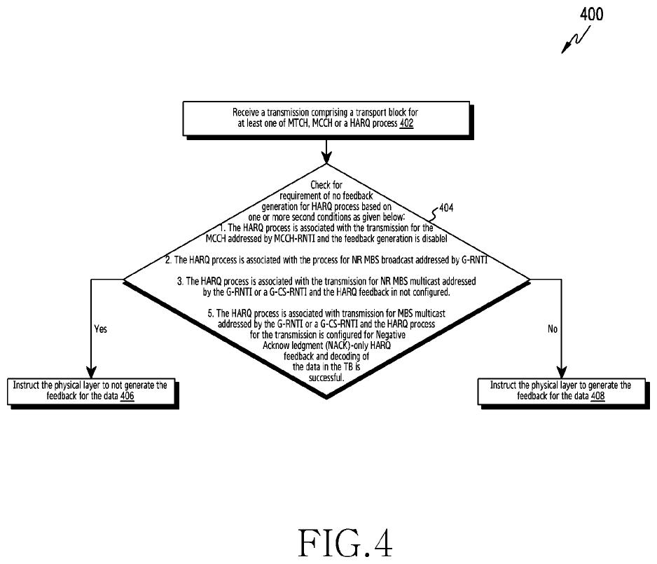

FIG. 4 illustrate a flowchart of a method (400) for operating a HARQ process of a UE (104) receiving a NR MBS in accordance with some embodiments related to HARQ feedback generation and no feedback generation of the present disclosure.

As illustrated in the FIG. 4, the method (400) includes one or more blocks illustrating method (400) for the HARQ process of the UE (104) receiving the NR MBS. The method (400) may be described in the general context of computer executable instructions. Generally, computer executable instructions can include routines, programs, objects, components, data structures, procedures, modules, and functions, which perform functions or implement abstract data types.

At block 402, the method (400) includes receiving, by a processor (106) of the UE (104), a transmission comprising a TB for at least one of MCCH and the MTCH from a network (102), for implementing the HARQ process.

At block 404, the method (400) includes determining, by the processor (106), a requirement of HARQ feedback generation or no HARQ feedback generation for the HARQ process associated with the transmission based on one or more second conditions related to at least one of the HARQ process, the MCCH, the MTCH for the NR MBS broadcast and the MTCH for the NR MBS multicast.

In some embodiments, the one or more second conditions may include, (1) when the HARQ process is associated with the transmission for the MCCH addressed by the MCCH-RNTI, (2) when the HARQ process is associated with the transmission for NR MBS broadcast addressed by the G-RNTI, (3) when the HARQ process is associated with the transmission for NR MBS multicast addressed by the G-RNTI or the G-CS-RNTI and the HARQ feedback is disabled, (4) when the HARQ process is associated with the transmission for the NR MBS multicast addressed by the G-RNTI or the G-CS-RNTI and the HARQ feedback is not configured, and (5) when the HARQ process is associated with the transmission for the NR MBS multicast addressed by the G-RNTI or the G-CS-RNTI, and the HARQ process for the transmission is configured for the NACK only HARQ feedback and decoding of the data in this TB is successful, then the method (400) proceed to block 406 via “Yes.” At block 406 the method includes performing, by the processor (106), instructing physical layer to not generate feedback for the data else the method proceeds to block 408 via “No.” At block 408 the method includes performing, by the processor (106), instructing the physical layer to generate feedback for the data.

In some embodiments, the one or more second conditions may include when the HARQ process is associated with the transmission for the NR MBS multicast indicated by configured multicast downlink assignment and the HARQ feedback is disabled, when the HARQ process is associated with the transmission for the NR MBS multicast indicated by configured multicast downlink assignment and the HARQ feedback is not configured, and when the HARQ process is associated with the transmission for the NR MBS multicast indicated by configured multicast downlink assignment, and the HARQ process for the transmission is configured for the NACK only HARQ feedback and decoding of the data in this TB is successful. That is, in these cases, the method includes performing, by the processor (106), instructing physical layer to not generate feedback for the data.

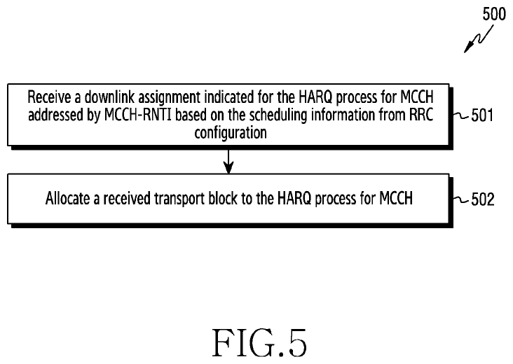

FIG. 5 illustrates a flowchart of a method (500) for determining a downlink assignment for HARQ process for MCCH in accordance with some embodiments of the present disclosure.

At block 501, the method (500) includes receiving the downlink assignment for the MCCH addressed by the MCCH-RNTI based on the scheduling information indicated by the RRC configuration from the network (102).

At block 502, the method (500) includes allocating a received TB to the HARQ process for the MCCH.

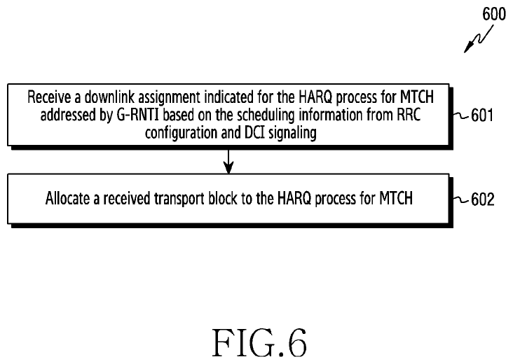

FIG. 6 illustrates a flowchart of a method (600) for determining a downlink assignment for HARQ process for MTCH in accordance with some embodiments of the present disclosure.

At block 601, the method (600) includes receiving the downlink assignment for the MTCH addressed by the G-RNTI based on the scheduling information indicated by the RRC configuration or DCI signaling from the network (102).

At block 602, the method (600) includes allocating a received TB to the HARQ process for the MTCH.

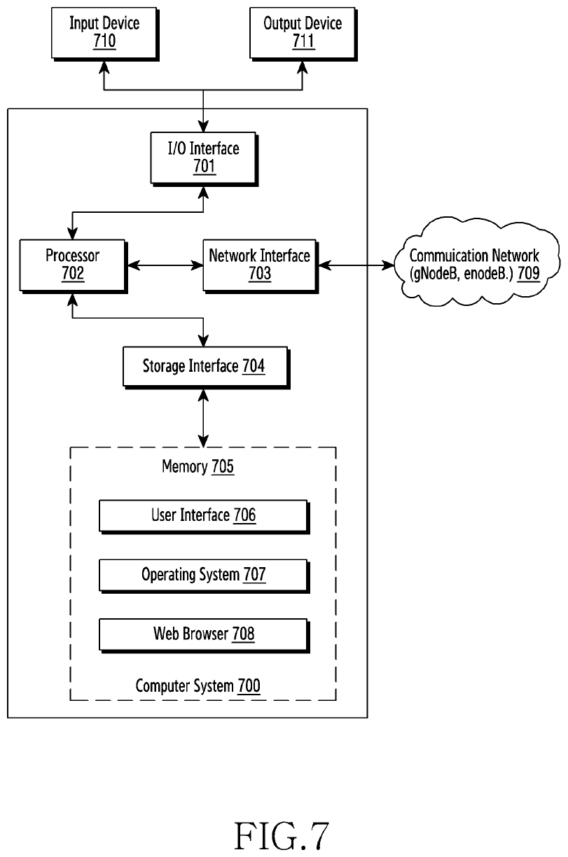

FIG. 7 illustrates a computer system (700) for implementing embodiments consistent with the present disclosure. In the context of the present disclosure, the computer system (700) may be the UE (104). Thus, the computer system (700) may be used to receive a NR MBS for a HARQ process. The computer system (700) may comprise a central processing unit (702) (also referred as “CPU” or “processor”). The processor (702) may comprise at least one data processor. The processor (702) may include specialized processing units such as integrated system (bus) controllers, memory management control units, floating point units, graphics processing units, digital signal processing units, etc. The processor (702) may be used to realize the processor (106) described in FIG. 2.

The processor (702) may be disposed in communication with one or more input/output (I/O) devices (not shown) via I/O interface (701). The I/O interface (701) may employ communication protocols/methods such as, without limitation, audio, analog, digital, monoaural, RCA, stereo, institute of electrical and electronics engineers (IEEE)-1394, serial bus, universal serial bus (USB), infrared, PS/2, BNC, coaxial, component, composite, digital visual interface (DVI), high-definition multimedia interface (HDMI), radio frequency (RF) antennas, S-video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (701), the computer system (700) may communicate with one or more I/O devices. For example, the input device (710) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (711) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor (702) may be disposed in communication with the communication network (709) via a network interface (703). The network interface (703) may communicate with the communication network (709). The network interface (703) may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network (709) may include, without limitation, a direct interconnection, local area network (LAN), wide area network (WAN), wireless network (e.g., using Wireless Application Protocol), the Internet, etc. The network interface (703) may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network (709) includes, but is not limited to, gNodeB, and eNodeB represented by (102) in FIG. 1, a direct interconnection, an e-commerce network, a peer to peer (P2P) network, local area network (LAN), wide area network (WAN), wireless network (e.g., using wireless application protocol), the Internet, Wi-Fi, and such. The first network and the second network may either be a dedicated network or a shared network, which represents an association of the different types of networks that use a variety of protocols, for example, hypertext transfer protocol (HTTP), transmission control protocol/Internet protocol (TCP/IP), wireless application protocol (WAP), etc., to communicate with each other. Further, the first network and the second network may include a variety of network devices, including routers, bridges, servers, computing devices, storage devices, etc.

In some embodiments, the processor (702) may be disposed in communication with a memory (705) (e.g., RAM, ROM, etc. not shown in FIG. 7) via a storage interface (704). The storage interface (704) may connect to memory (705) including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory (705) may store a collection of program or database components, including, without limitation, user interface (706), an operating system (707), web browser (708) etc. In some embodiments, the computer system (700) may store user/application data, such as, the data, variables, records, etc., as described in this disclosure. Such databases may be implemented as fault-tolerant, relational, scalable, secure databases such as Oracle® or Sybase®. The memory (705) may be used to realize the memory (110) described in FIG. 2. The memory (705) may be communicatively coupled to the processor (702). The memory (705) stores instructions, executable by the one or more processors (702), which, on execution, may cause the processor (702) for operating the HARQ process of the UE (104) for receiving the NR MBS.

The operating system (707) may facilitate resource management and operation of the computer system (700). Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system (700) may implement the web browser (708) stored program component. The web browser (708) may be a hypertext viewing application, for example MICROSOFT® INTERNET EXPLORER™, GOOGLE® CHROME^{TM0}, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers (708) may utilize facilities such as AJAX™, DHTML™, ADOBE® FLASH™, JAVASCRIPT™, JAVA™, Application Programming Interfaces (APIs), etc. In some embodiments, the computer system (700) may implement a mail server (not shown in Figure) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™ JAVASCRIPT™, PERL™ PHP™ PYTHON™, WEBOBJECTS™, etc.

The mail server may utilize communication protocols such as Internet message access protocol (IMAP), messaging application programming interface (MAPI), MICROSOFT® exchange, post office protocol (POP), simple mail transfer protocol (SMTP), or the like. In some embodiments, the computer system (700) may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, compact disc read-only memory (CD ROMs), digital video disc (DVDs), flash drives, disks, and any other known physical storage media.

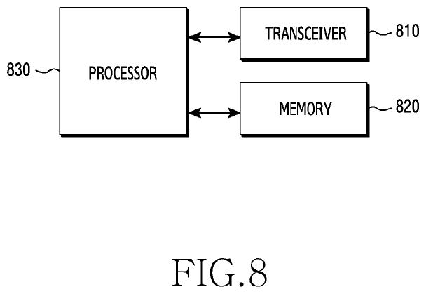

As shown in FIG. 8 is, the UE of the present disclosure may include a transceiver 810, a memory 820, and a processor (or, a controller) 830. The transceiver 810, the memory 820, and the processor (or controller) 830 of the UE may operate according to a communication method of the UE described above. However, the components of the UE are not limited thereto. For example, the UE may include more or fewer components than those described in FIG. 8. In addition, the processor (or controller) 830, the transceiver 810, and the memory 820 may be implemented as a single chip. Also, the processor (or controller) 830 may include at least one processor. FIG. 8 corresponds to the example of the UE of at least one of FIG. 1, 2, or 3.

The transceiver 810 collectively refers to a UE receiver and a UE transmitter, and may transmit/receive a signal to/from another UE, and/or a gNB. The signal transmitted or received to or from the UE may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor (or controller) 830, a signal through a wireless channel, and transmit a signal output from the processor (or controller) 830 through the wireless channel.

The memory 820 may store a program and data required for operations of the UE. Also, the memory 820 may store control information or data included in a signal obtained by the UE. The memory 820 may be a storage medium, such as ROM, RAM, a hard disk, a CD-ROM, and a DVD, or a combination of storage media.

The processor (or controller) 830 may control a series of processes such that the UE operates as described above. For example, the processor (or controller) 830 may receive a data signal and/or a control signal, and the processor (or controller) 830 may determine a result of receiving the signal transmitted by the terminal and/or the core network function.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The present disclosure may provide standardized and specified approach facilitates inter-operability for HARQ process operation across NR MBS broadcast, multicast and unicast. The present disclosure provides a standardized approach for the HARQ process including HARQ process assignment or usage for the NR MBS broadcast, repetitions for the NR MBS broadcast, determination for a new transmission and a retransmission for the NR MBS broadcast, determination for HARQ feedback generation or no HARQ feedback generation for NR MBS multicast and the NR MBS broadcast. This standardized approach ensures inter-operability between the UEs and the network such that the UE implementation is governed and guided. Further, the present disclosure ensures accuracy, efficiency of the operation and UE/network which are able to achieve NR MBS operation in an optimum manner with respect to well designed and specified approaches for HARQ process operation, transmission/retransmission and HARQ feedback generation.

In light of the technical advancements provided by the disclosed method and the control module, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

It will be understood by a person skilled in the art that the various descriptive logic blocks, modules, circuits, and steps described in the present application may be implemented as hardware, software, or a combination of both. To clearly illustrate this interchangeability of hardware and software, the various descriptive components, blocks, modules, circuits, and steps are described above in general terms in terms of their functional sets. Whether such functional sets are implemented as hardware or software depends on the specific application and the design constraints imposed on the overall system. The skilled may implement the described functional set in different ways for each particular application, but such design decisions should not be construed as departing from the scope of the present application.

The individual descriptive logic blocks, modules, and circuits described in the present application may be implemented or executed with a general-purpose processor, a digital signal processor (DSP), an application-specific integrated circuit (ASIC), a field programmable gate array (FPGA), or another programmable logic device, discrete gates or transistor logic, discrete hardware components, or any combination thereof designed to perform the functions described herein. The general-purpose processor may be a microprocessor, but in alternatives, the processor may be any conventional processor, controller, microcontroller, or state machine. The processor may be implemented as a combination of computing devices, such as a combination of a DSP and a microprocessor, a plurality of microprocessors, one or more microprocessors in collaboration with a DSP core, or any other such configuration.

The steps of the method or algorithm described in the present application may be embodied directly in hardware, in a software module executed by a processor, or in a combination of the two. The software module may reside in a RAM storage, a flash memory, a ROM storage, an EPROM storage, an EEPROM storage, a register, a hard disk, a removable disk, or any other form of storage medium known in the art. An exemplary storage medium is coupled to a processor to enable the processor to read and write information from/to the storage medium. In alternatives, the storage medium may be integrated into the processor. The processor and the storage medium may reside in an ASIC, which may reside in a user terminal. In alternatives, the processor and the storage medium may reside in the user terminal as discrete components.

The terms “an embodiment,” “embodiment,” “embodiments,” “the embodiment,” “the embodiments,” “one or more embodiments,” “some embodiments,” and “one embodiment” mean “one or more (but not all) embodiments of the present disclosure” unless expressly specified otherwise.

The terms “including,” “comprising,” “having” and variations thereof mean “including but not limited to,” unless expressly specified otherwise.

The enumerated listing of items does not imply that any or all the items are mutually exclusive, unless expressly specified otherwise. The terms “a,” “an” and “the” mean “one or more,” unless expressly specified otherwise.

A description of an embodiment with several components in communication with each other does not imply that all such components are required. On the contrary, a variety of optional components are described to illustrate the wide variety of possible embodiments of the present disclosure.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of present disclosure need not include the device itself.

Finally, the language used in the specification has been principally selected for readability and instructional purposes, and it may not have been selected to delineate or circumscribe the inventive subject matter. It is, therefore, intended that the scope of the present disclosure be limited not by this detailed description, but rather by any claims that issue on an application based here on. Accordingly, the embodiments of the present disclosure are intended to be illustrative, but not limiting, of the scope of the present disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
obtaining a transport block (TB) of a transmission associated with a hybrid automatic repeat request (HARQ) process; and
determining that the transmission is a new transmission based on a first condition, wherein the first condition includes that:
the HARQ process is associated with a transmission indicated with a multicast, and broadcast service control channel-radio network temporary identifier (MCCH-RNTI) for a multicast and broadcast service (MBS) broadcast and the transmission is a first received transmission for the TB according to an MCCH schedule indicated by a radio resource control (RRC), or
the HARQ process is associated with a transmission indicated with a group-RNTI (G-RNTI) for a MBS broadcast, and the transmission is a first received transmission for the TB according to a multicast and broadcast service traffic channel (MTCH) schedule indicated by the RRC or according to a schedule indicated by a downlink control indicator (DCI).

2. The method of claim 1, further comprising:
in case that the transmission is the new transmission, decoding data included in the TB, and
delivering the decoded data to an entity.

3. The method of claim 1, further comprising:
in case that the transmission is a retransmission, decoding the TB by combining data included in the TB with stored data related to the TB.

4. The method of claim 1,
wherein, in case that the HARQ process is associated with the transmission indicated with the MCCH-RNTI, the transmission includes a downlink assignment and redundancy version for the HARQ process.

5. The method of claim 1,
wherein RRC configuration information for the transmission includes a physical downlink shared channel (PDSCH) aggregation factor indicating a number of repeated transmissions for the TB.

6. The method of claim 2,
wherein the entity includes a disassembly and demultiplexing entity.

7. The method of claim 1, further comprising:
identifying whether an instruction a physical layer to generate acknowledgment feedback is instructed based on a second condition being satisfied, the second condition including that:
the HARQ process is associated with a transmission indicated with a G-RNTI or a G-configured scheduling-RNTI (G-CS-RNTI) for a MBS multicast and a HARQ feedback is disabled, or
the HARQ process is associated with the transmission indicated with the G-RNTI or the G-CS-RNTI for the MBS multicast and a negative acknowledgement (NACK) only HARQ feedback is configured and data for the TB is successfully decoded,
not instructing the instruction the physical layer to generate acknowledgment feedback based on the second condition being satisfied.

8. The method of claim 1, wherein the HARQ process is performed by at least one medium access control (MAC) entity of the UE.

9. The method of claim 1, further comprising:
receiving scheduling information for one of:
the MCCH from radio resource control (RRC) configuration prior to receiving the transmission, or
the MTCH from at least one of the RRC configuration prior to receiving the transmission and a DCI signaling during the transmission,
wherein the scheduling information comprises transmission associated information.

10. The method of claim 9, wherein the transmission associated information comprises at least one of time of occurrence of the transmission, a start of the transmission, a duration of the transmission, a downlink assignment, a redundancy version and HARQ information for the transmission.

11. A user equipment (UE) in a wireless communication system, the UE comprising:
a transceiver; and
a controller coupled with the transceiver and configured to:
obtain a transport block (TB) of a transmission associated with a hybrid automatic repeat request (HARQ) process; and
determine that the transmission is a new transmission based on a first condition, wherein the first condition includes that:
the HARQ process is associated with a transmission indicated with a multicast, and broadcast service control channel-radio network temporary identifier (MCCH-RNTI) for a multicast and broadcast service (MBS) broadcast and the transmission is a first received transmission for the TB according to an MCCH schedule indicated by a radio resource control (RRC), or
the HARQ process is associated with a transmission indicated with a group-RNTI (G-RNTI) for a MBS broadcast, and the transmission is a first received transmission for the TB according to a multicast and broadcast service traffic channel (MTCH) schedule indicated by the RRC or according to a schedule indicated by a downlink control indicator (DCI).

12. The UE of claim 11, wherein the controller is further configured to:
in case that the transmission is the new transmission, decode data included in the TB, and
deliver the decoded data to an entity.

13. The UE of claim 11, wherein the controller is further configured to:
in case that the transmission is a retransmission, decode the TB by combining data included in the TB with stored data related to the TB.

14. The UE of claim 11,
wherein, in case that the HARQ process is associated with the transmission indicated with the MCCH-RNTI, the transmission includes a downlink assignment and redundancy version for the HARQ process.

15. The UE of claim 11,
wherein RRC configuration information for the transmission includes a physical downlink shared channel (PDSCH) aggregation factor indicating a number of repeated transmissions for the TB.

16. The UE of claim 12,
wherein the entity includes a disassembly and demultiplexing entity.

17. The UE of claim 11, wherein the controller is further configured to:
identify whether an instruction a physical layer to generate acknowledgment feedback is instructed based on a second condition being satisfied, the second condition including that:
the HARQ process is associated with a transmission indicated with a G-RNTI or a G-configured scheduling-RNTI (G-CS-RNTI) for a MBS multicast and a HARQ feedback is disabled, or
the HARQ process is associated with the transmission indicated with the G-RNTI or the G-CS-RNTI for the MBS multicast and a negative acknowledgement (NACK) only HARQ feedback is configured and data for the TB is successfully decoded,
not instruct the instruction the physical layer to generate acknowledgment feedback based on the second condition being satisfied.

18. The UE of claim 11, wherein the HARQ process is performed by at least one medium access control (MAC) entity of the UE.

19. The UE of claim 11, wherein the controller is further configured to:
receive scheduling information for one of:
the MCCH from radio resource control (RRC) configuration prior to receiving the transmission, or
the MTCH from at least one of the RRC configuration prior to receiving the transmission and a DCI signaling during the transmission,
wherein the scheduling information comprises transmission associated information.

20. The UE of claim 19, wherein the transmission associated information comprises at least one of time of occurrence of the transmission, a start of the transmission, a duration of the transmission, a downlink assignment, a redundancy version and HARQ information for the transmission.
